(19) United States
(12) Patent Application Publication
(10) Pub. No.: US 2005/0052553 A1
(43) Pub. Date: Mar. 10, 2005

(54) Image capturing apparatus

(76) Inventors: Toshihito Kido, Osaka (JP); Takuya Kishimoto, Osaka (JP)

Correspondence Address: Brinks Hofer Gilson & Lione, P.O. Box 10395, Chicago, IL, 60610, US

(21) Appl. No.: 10/730,686

(22) Filed: Dec. 8, 2003

(30) Foreign Application Priority Data
Sep. 9, 2003 (JP) P2003-316679

(51) Int. Cl. H04N 3/14; H04N 5/335; H04N 5/222

(52) U.S. Cl. 348/296; 348/333.01

(57) ABSTRACT

A digital camera capable of capturing, displaying and recording images at appropriate frame rates is provided. When a current shooting scene mode is a non-sport mode, a current readout mode and a current display mode are set to a high-definition readout mode and a high-definition display mode, respectively, at the same time. Additionally, when a current operating mode is a moving image capturing mode, a current recording mode is also set to a high-definition recording mode at the same time. When the current shooting scene mode is a sport mode, on the other hand, the current readout mode and the current display mode are set to a high-speed readout mode and a high-speed display mode, respectively, at the same time. Additionally, when the current operating mode is the moving image capturing mode, the current recording mode is also set to a high-speed recording mode. The digital camera increases the image-capturing frame rate, the display frame rate and the recording frame rate in synchronism with each other in response to a change of the current shooting scene mode from the non-sport mode to the sport mode.

This application is based on application No. 2003-316679 filed in Japan, the contents of which are hereby incorporated by reference.

### BACKGROUND OF THE INVENTION

1. Field of the Invention

The present invention relates to an image capturing apparatus.

2. Description of the Background Art

In general, a digital camera performs image processing on image data generated by an image capturing part such as a CCD, and displays an image associated with the image data subjected to the image processing on a display part such as an LCD device. Additionally, the digital camera records the image data subjected to the image processing on a recording part such as a memory card.

In such a digital camera, the image capturing part generates image data at a predetermined frame rate during shooting standby pending still image capturing or during moving image capturing, and the display part displays images at a predetermined frame rate. Such image display is known as live view display and is used for framing or the like by a user. Additionally, image data is recorded on the recording part in such a digital camera at a predetermined frame rate during moving image capturing. Images associated with the recorded image data are played back and displayed as playback images by a predetermined method.

The display quality (or appearance) of such live view images and playback images depends on the above-mentioned frame rates. The increase in frame rates enables the live view images and the playback images to faithfully reflect the motion of a subject (to make a change from a stiff motion to a smooth motion). A variety of techniques for increasing the frame rates of the image capturing part, the display part and the recording part have been contemplated.

For example, Japanese Patent Application Laid-Open No. 2002-300457 discloses a technique for increasing a frame rate by displaying an image cut from a captured image on a monitoring screen during a high-speed focusing operation.

The technique disclosed in Japanese Patent Application Laid-Open No. 2002-300457 can increase the frame rate of the display part. This technique, however, does not organically increase the frame rates of the image capturing part, the display part and the recording part, to fail to make full use of the capabilities of the image capturing part, the display part and the recording part. It is therefore difficult to capture, display and record images at appropriate frame rates.

### SUMMARY OF THE INVENTION

The present invention is intended for an image capturing apparatus.

According to a first aspect of the present invention, the image capturing apparatus comprises: an image capturing part for capturing an image of a subject at a variable image-capturing frame rate to generate image data; a display part for displaying an image associated with the image data at a variable display frame rate; and a controller for controlling the image capturing part and the display part, the controller being capable of performing a frame rate change process, wherein the controller changes the image-capturing frame rate and the display frame rate in synchronism with each other from a first frame rate to a second frame rate in the frame rate change process.

The image capturing apparatus changes the image-capturing frame rate and the display frame rate in synchronism with each other, to allow the browsing of images at the appropriate display frame rate.

According to a second aspect of the present invention, the image capturing apparatus capable of capturing a moving image comprises: an image capturing part for capturing an image of a subject at a variable image-capturing frame rate to generate image data; a recording part for recording the image data at a variable recording frame rate; and a controller for controlling the image capturing part and the recording part, the controller being capable of performing a frame rate change process, wherein the controller changes the image-capturing frame rate and the recording frame rate in synchronism with each other from a first frame rate to a second frame rate in the frame rate change process.

The image capturing apparatus changes the image-capturing frame rate and the recording frame rate in synchronism with each other, to allow the recording of images at the appropriate recording frame rate.

According to a third aspect of the present invention, the image capturing apparatus comprises: an image capturing part for capturing an image of a subject at a variable image-capturing frame rate to generate image data; a display part for displaying an image associated with the image data at a variable display frame rate; and a controller for controlling the image capturing part and the display part, wherein the controller sets the image-capturing frame rate and the display frame rate to the same control frame rate at the same time.

The image capturing apparatus sets the image-capturing frame rate and the display frame rate to the same frame rate at the same time, to allow the browsing of images at the appropriate display frame rate.

According to a fourth aspect of the present invention, the image capturing apparatus comprises: an image capturing part for capturing an image of a subject at a variable image-capturing frame rate to generate image data; a recording part for recording the image data at a variable recording frame rate; and a controller for controlling the image capturing part and the recording part, wherein the controller sets the image-capturing frame rate and the recording frame rate to the same control frame rate at the same time.

The image capturing apparatus sets the image-capturing frame rate and the recording frame rate to the same frame rate at the same time, to allow the recording of images at the appropriate recording frame rate.

It is therefore an object of the present invention to provide a digital camera capable of capturing, displaying and recording images at appropriate frame rates.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a digital camera;

FIG. 2 is a sectional view of the digital camera taken along the line II-II of FIG. 1;

FIG. 3 is a rear view of the digital camera;

FIG. 4 is a block diagram illustrating the internal construction of the digital camera;

FIG. 5 shows an image divided into a plurality of equal areas;

FIG. 6 shows another image divided into a plurality of equal areas;

FIG. 7 illustrates a readout method in an all-pixel readout mode;

FIG. 8 illustrates a readout method in a high-definition readout mode;

FIG. 9 illustrates a readout method in a high-speed readout mode;

FIG. 10 illustrates a scanning method in a high-definition display mode;

FIG. 11 illustrates a scanning method in a high-speed display mode;

FIG. 12 illustrates a relationship between shooting scene modes, operating modes, readout modes, display modes and recording modes;

FIG. 13 is a flowchart illustrating a frame rate change operation of the digital camera;

FIG. 14 is a flowchart illustrating a subroutine for a still image capturing mode in the digital camera;

FIG. 15 is a flowchart illustrating a subroutine for a moving image capturing mode in the digital camera;

FIG. 16 is a flowchart illustrating a subroutine for a playback mode in the digital camera;

FIG. 17 is a flowchart illustrating a subroutine for the still image capturing mode in a second digital camera;

FIG. 18 is a flowchart illustrating a subroutine for the moving image capturing mode in the second digital camera; and

FIG. 19 is a flowchart illustrating a subroutine for the still image capturing mode in a third digital camera.

### DESCRIPTION OF THE PREFERRED EMBODIMENTS

Digital cameras 1A to 1C according to first to third preferred embodiments of the present invention feature a variable image-capturing frame rate of an image capturing part, a variable display frame rate of a display part, and a variable recording frame rate of a recording part. The digital cameras 1A to 1C also feature variable resolutions of image data generated by the image capturing part, image data about an image displayed on the display part, and image data recorded on the recording part.

The digital camera 1A according to the first preferred embodiment performs the processes of changing the frame rate and the resolution in response to a change of a set shooting scene.

The digital camera 1B according to the second preferred embodiment performs the processes of changing the frame rate and the resolution, based on a result of detection of the motion of a main subject included in a subject when the set shooting scene is a specific shooting scene.

The digital camera 1C according to the third preferred embodiment changes the specific method of the processes of changing the frame rate and the resolution in response to a change of a set exposure mode.

<<First Preferred Embodiment>>

The digital camera 1A according to the first preferred embodiment is capable of capturing both a still image and a moving image.

The digital camera 1A has a plurality of shooting scene modes selectable by the use of a shooting scene selection button. The plurality of shooting scene modes include six modes: a “portrait mode,” a “sport mode,” an “evening scene mode,” a “night scene portrait and night scene mode,” a “text mode” and a “program mode.” The digital camera 1A performs the processes of changing the frame rate and the resolution in response to a change of a current shooting scene mode. In the digital camera 1A, an image capturing range is held fixed when the frame rate and the resolution are changed.

<Basic Construction of Digital Camera 1A>

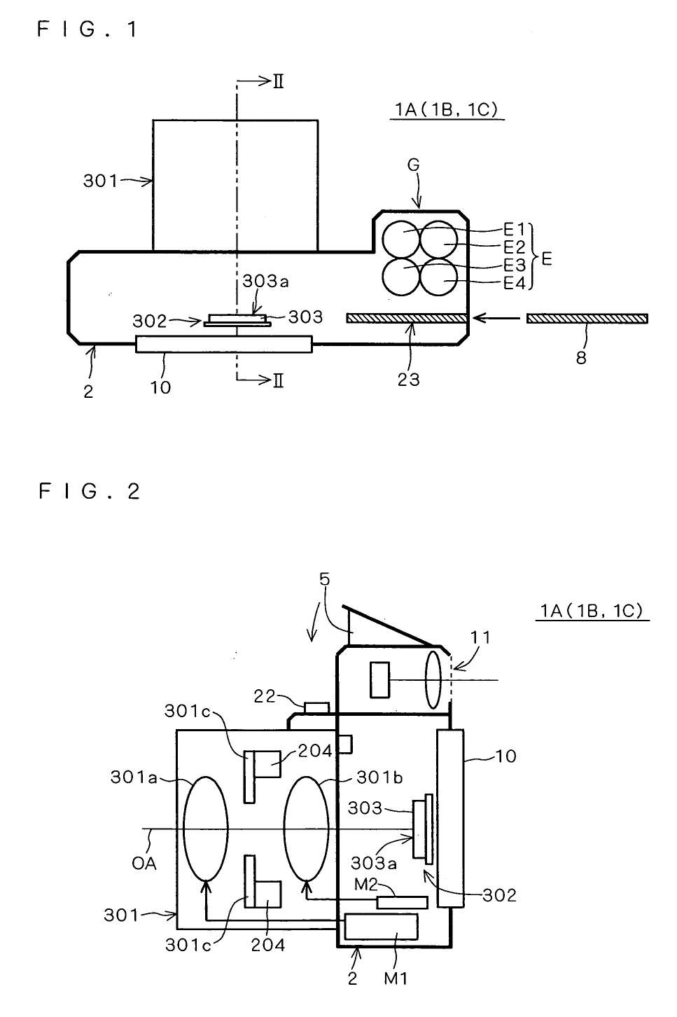

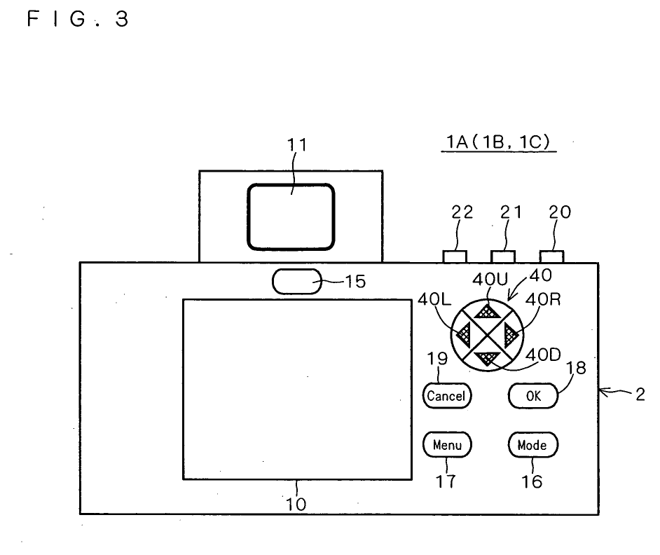

A basic construction of the digital camera 1A will be described with reference to FIGS. 1 to 3. FIG. 1 is a plan view of the digital camera 1A. FIG. 2 is a sectional view of the digital camera 1A taken along the line II-II of FIG. 1. FIG. 3 is a rear view of the digital camera 1A.

The digital camera 1A comprises a taking lens device 301 which is a zoom lens device with macro capability. An image capturing circuit 302 having a CCD (Charge Coupled Device) 303 serving as a color area sensor is provided behind the taking lens device 301. The image capturing circuit 302 is positioned so that an optical image of a subject passing through the taking lens device 301 is image-formed on a light receiving surface 303a of the CCD 303. Inside the taking lens device 301, there are provided a zoom lens element 301a for changing the focal length of the taking lens device 301, a focusing lens element 301b for changing the focusing of the optical image image-formed on the light receiving surface 303a, and a diaphragm 301c for changing the amount of light reaching the light receiving surface 303a. The zoom lens element 301a and the focusing lens element 301b are connected respectively to a zoom motor M1 and an autofocus (AF) motor M2 both provided inside a camera body 2, and are movable in the direction of the optical axis OA of the digital camera 1A. The diaphragm 301c is connected to a diaphragm control driver 204, and is capable of changing the aperture diameter thereof.

The front surface of the camera body 2 is provided with a grip G. A pop-up built-in flash 5 is provided in an upper end part of the camera body 2.

A shutter release button 20, a shooting scene selection button 21 and an exposure mode selection button 22 are provided on the upper surface of the camera body 2. The shutter release button 20 is a pushbutton switch capable of detecting a half-pressed position (S1) and a fully-pressed position (S2). The digital camera 1A commences a shooting-ready operation including AF control and the like upon detecting that the shutter release button 20 is placed in the half-pressed position (S1), and commences an actual shooting operation upon detecting that the shutter release button 20 is placed in the fully-pressed position (S2). In response to a press of the shooting scene selection button 21 by a user, the digital camera 1A changes the current shooting scene mode in order between the “portrait mode,” the “sport mode,” the “evening scene mode,” the “night scene portrait and night scene mode,” the “text mode,” and the “program mode.” In response to a press of the exposure mode selection button 22 by the user, the digital camera 1A changes the current exposure mode in order between a “program mode,” an “aperture priority mode” and a “shutter speed priority mode.”

With reference to FIG. 3, the rear surface of the digital camera 1A is provided with a liquid crystal display (LCD) 10 in its generally midportion for producing a live view display in a shooting standby state and for displaying a playback of a recorded image. An electronic viewfinder (EVF) 11 for producing a live view display and a playback display in a similar manner to the LCD 10 is provided over the LCD 10. An eye sensor 15 for detecting the proximity of an eye to the EVF 11 is provided under the EVF 11.

An mode selection button 16, a menu button 17, an OK button 18 and a cancel button 19 are provided on the right-hand side of the rear surface of the digital camera 1A.

In response to a press of the mode selection button 16 by the user, the digital camera 1A changes a current operating mode in order between a “still image capturing mode,” a “moving image capturing mode,” and a “playback mode.” The “still image capturing mode” is an operating mode for capturing a still image, and the “moving image capturing mode” is an operating mode for capturing a moving image. The “playback mode” is an operating mode for displaying on the LCD 10 and the EVF 11 a playback of image data recorded on a memory card 8.

The menu button 17, the OK button 18 and the cancel button 19 are used for various menu manipulations on the digital camera 1A.

A four-way switch 40 is provided on the right-hand side of the rear surface of the digital camera 1A. The four-way switch 40 includes four buttons 40U, 40D, 40L and 40R. The four-way switch 40 is used for the above-mentioned various menu manipulations. Additionally, the buttons 40R and 40L function as control members for changing the focal length (or zoom magnification) of the taking lens device 301 when the digital camera 1A is in the “still image capturing mode” and in the “moving image capturing mode.”

As shown in FIG. 1, a memory card slot 23 for receiving the memory card 8 therein is provided in one side surface of the digital camera 1A. The digital camera 1A can incorporate four AA cells E1 to E4 into the camera body 2. A power battery E comprised of the four AA cells E1 to E4 connected in series serves as a power source for driving the digital camera 1A.

<Internal Construction of Digital Camera 1A>

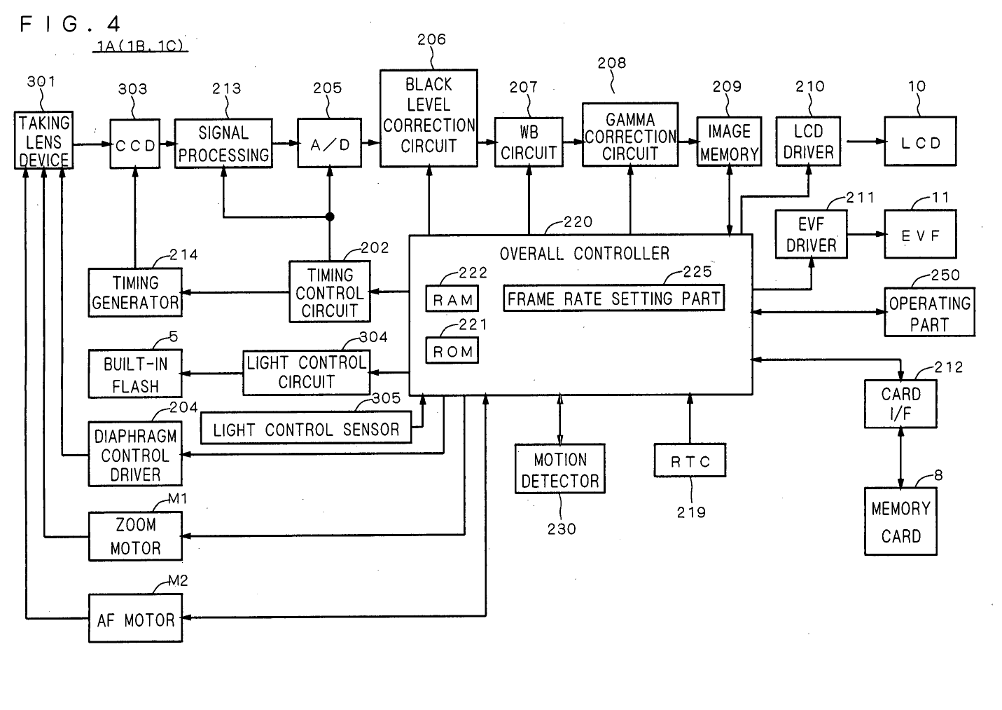

An internal construction of the digital camera 1A will be described with reference to the block diagram of FIG. 4.

As described above, the taking lens device 301 is capable of changing the focal length, the focusing and the aperture diameter by the use of the zoom motor M1, the AF motor M2 and the diaphragm control driver 204. The zoom motor M1, the AF motor M2 and the diaphragm control driver 204 operate based on control signals provided from an overall controller 220.

The optical image of the subject image-formed on the light receiving surface 303a of the CCD 303 by the taking lens device 301 is photoelectrically converted by the CCD 303 into an image signal having R (red), G (green) and B (blue) color components. The image signal includes a sequence of pixel signals reflecting the amounts of light received by light-sensitive pixels (photodetectors) constituting the CCD 303. The light-sensitive pixels of the CCD 303 are arranged in a matrix with 2560 columns and 1920 rows. Each of the light-sensitive pixels of the CCD 303 is masked by a color filter of any one of the R, G and B colors arranged in Bayer pattern. The color component of the pixel signal read from each of the light-sensitive pixels is determined by the color of the color filter masking each light-sensitive pixels.

The image capturing operation of the CCD 303 is in synchronism with timing pulses provided from a timing generator 214. The timing pulses include an integration start/end (exposure start/end) timing signal, and read control signals (a horizontal sync signal, a vertical sync signal, a transfer sync signal, and the like) for the pixel signals stored in the light-sensitive pixels.

The digital camera 1A changes the timing signal to change the exposure time (charge storage time) of the CCD 303 corresponding to a shutter speed.

The digital camera 1A changes the read control signals to change light-sensitive pixels from which pixel signals are to be read. More specifically, the CCD 303 can read the pixel signals in three readout modes: an “all-pixel readout mode,” a “high-definition readout mode” and a “high-speed readout mode.” The CCD 303 outputs 1920 rows, 240 rows and 120 rows among the 1920 rows of pixels in the “all-pixel readout mode,” the “high-definition readout mode” and the “high-speed readout mode,” respectively. The image-capturing frame rate (the number of times of image capturing per second) is 30 fps in the “high-definition readout mode,” and 60 fps in the “high-speed readout mode.” In other words, the image-capturing frame rate and the image-capturing resolution of image data to be generated are variable in the CCD 303 and the timing generator 214 which are principal components of the image capturing part of the digital camera 1A. The “high-definition readout mode” is a readout mode having a relatively high resolution and a relatively low frame rate. The “high-speed readout mode” is a readout mode having a relatively low resolution and a relatively high frame rate. In either of the “high-definition readout mode” and the “high-speed readout mode,” image processing loads on components in subsequent stages are constant. A readout method in the digital camera 1A is determined so that the reduction in the number of light-sensitive pixels from which the pixel signals are to be read does not cause the reduction in image capturing range (or angle of view), which will be described later.

A signal processing circuit 213 performs predetermined analog signal processing upon the analog image signal received from the CCD 303. The signal processing circuit 213 comprises a CDS (correlated double sampling) circuit and an AGC (automatic gain control) circuit. The CDS circuit performs a noise reduction process on the image signal, and the AGC circuit adjusts the level of the image signal. The signal processing circuit 213 performs the analog image signal processing in synchronism with a clock provided from a timing control circuit 202.

In the digital camera 1A, an aperture value and a shutter speed are determined based on a predetermine program line (control data which describes a relationship between the aperture value and the shutter speed for each focal length). If a proper shutter speed cannot be set due to a low subject brightness, incorrect exposure is corrected by increasing the gain of the AGC circuit.

An A/D converter 205 converts each of the pixel signals constituting the analog image signal subjected to the analog signal processing in the signal processing circuit 213 into a 12-bit digital signal to output the digital signal. The A/D converter 205 performs this A/D conversion process in synchronism with the clock provided from the timing control circuit 202.

The timing control circuit 202 provides the operation control clock to the signal processing circuit 213 and the A/D converter 205, and also provides a reference clock to the timing generator 214. The timing generator 214 generates the timing pulses based on the reference clock. The overall controller 220 controls the generation of the various clocks in the timing control circuit 202.

A black level correction circuit 206 corrects the black level of the image data provided from the A/D converter 205 to output a predetermined black level to a WB (white balance) circuit 207.

The WB circuit 207 converts the levels of pixel data about the R, G and B color components included in the image data provided from the black level correction circuit 206 to provide an output to a gamma correction circuit 208. The WB circuit 207 performs this level conversion by the use of a level conversion table LUT provided from the overall controller 220. Level conversion factors (the gradients of characteristic curves) for the respective color components in the level conversion table LUT are established for each captured image by the overall controller 220.

The gamma correction circuit 208 performs a gamma correction on the pixel data included in the image data to provide an output to an image memory 209. The image memory 209 is capable of storing at least several frames. In other words, the image memory 209 has a storage capacity several times greater than the amount of pixel data for the light-sensitive pixels (approximately 4.92 million pixels) of the CCD 303.

An LCD driver 210 is a driver for outputting a scanning signal to the LCD 10 to cause the LCD 10 to display the image data provided from the overall controller 220 as an image. The LCD driver 210 includes a buffer memory capable of storing image data for the display pixels (320 pixels wide by 240 pixels high) of the LCD 10. The digital camera 1A changes the scanning method to change the display resolution of image data displayable on the LCD 10. More specifically, the LCD driver 210 can scan the LCD 10 in two display modes: a “high-definition display mode” and a “high-speed display mode.” The display resolution of image data displayable is 320 pixels wide by 240 pixels high in the “high-definition display mode,” and 320 pixels wide by 120 pixels high in the “high-speed display mode.” The display frame rate (the number of times of display refresh per second) is 30 fps in the “high-definition display mode,” and 60 fps in the “high-speed display mode.” In other words, the display frame rate and the display resolution of image data displayable are variable in the LCD driver 210 and the LCD 10 which are principal components of the display part of the digital camera 1A. The “high-definition display mode” is a display mode having a relatively high resolution and a relatively low frame rate. The “high-speed display mode” is a display mode having a relatively low resolution and a relatively high frame rate. In either of the “high-definition display mode” and the “high-speed display mode,” image processing loads on components in previous stages are constant.

An EVF driver 211 is a driver for outputting a scanning signal to the EVF 11 to cause the EVF 11 to display the image data provided from the overall controller 220 as an image. The EVF driver 211 includes a buffer memory capable of storing image data for the display pixels (640 pixels high by 480 pixels wide) of the EVF 11.

In a shooting standby state in the “still image capturing mode” and in the “moving image capturing mode” of the digital camera 1A, image data about images captured by the CCD 303 at the image-capturing frame rate of 30 fps or 60 fps is subjected to the image processing in the signal processing circuit 213, the A/D converter 205, the black level correction circuit 206, the WB circuit 207 and the gamma correction circuit 208. Thereafter, the processed image data is temporarily stored in the image memory 209. The image data temporarily stored in the image memory 209 is transferred through the overall controller 220 to the LCD driver 210 and the EVF driver 211. In this process, the overall controller 220 performs a resolution conversion process for reducing the 2560 columns of the input image data to 320 columns equal in number to the columns of the LCD 10. This allows the images captured by the CCD 303 to be displayed as a live view on the LCD 10 and the EVF 11 at the display frame rate of 30 fps or 60 fps. This live view is used for framing or the like by a user.

During actual shooting in the “still image capturing mode” of the digital camera 1A, image data about an image captured by the CCD 303 is subjected to the image processing in the signal processing circuit 213, the A/D converter 205, the black level correction circuit 206, the WB circuit 207 and the gamma correction circuit 208. Thereafter, the processed image data is temporarily stored in the image memory 209. The image data temporarily stored in the image memory 209 is subjected to a predetermined process in the overall controller 220, and the processed image data is recorded on the memory card 8. The predetermined process in the overall controller 220 includes an image data compression process, a tag information addition process, and the like.

During actual shooting in the “moving image capturing mode” of the digital camera 1A, image data (moving image data) about images captured by the CCD 303 is recorded on the memory card 8, in addition to being displayed as a live view display similar to that in the shooting standby state. The recording frame rate at which the image data is recorded is 30 fps or 60 fps.

In the “playback mode” of the digital camera 1A, the image data read from the memory card 8 is subjected to a predetermined process by the overall controller 220. The processed image data is transferred to the LCD driver 210 and the EVF driver 211. This allows the LCD 10 and the EVF 11 to display a playback of the read image data. The predetermined process in the overall controller 220 includes the process of decompressing the compressed image data, and the like.

A card interface (I/F) 212 is an interface for writing image data therethrough into the memory card 8 and for reading image data therethrough from the memory card 8.

An RTC (Real Time Clock) 219 is a clock circuit driven by a power supply (not shown) other than the power battery E. The RTC 219 is used for management of the date and time of shooting.

A light control circuit 304 controls the amount of light to be emitted from the built-in flash 5 during flash photography to a predetermined amount established by the overall controller 220. In the flash photography, a light control sensor 305 detects the flash light reflected from the subject. A value detected by the light control sensor 305 is used for control of the amount of light to be emitted from the built-in flash 5.

A motion detector 230 detects the motion of a main subject included in the subject in the direction of the optical axis OA and in a direction perpendicular to the optical axis OA. A result of detection of the motion detector 230 is outputted to the overall controller 220. This result of detection is used for AF control in the digital camera 1A and for judgment as to whether or not to execute the processes of changing the frame rate and the resolution.

An operating part 250 includes the above-mentioned mode selection button 16, menu button 17, OK button 18, cancel button 19, shutter release button 20, shooting scene selection button 21, exposure mode selection button 22 and four-way switch 40. How the operating part 250 is manipulated is detected by the overall controller 220.

<Overall Controller 220>

The overall controller 220 is a microcomputer comprising a ROM 221 and a RAM 222. The overall controller 220 executes a control program stored in the ROM 221 to exercise centralized control over the components of the digital camera 1A.

A function implemented by the microcomputer is schematically represented in FIG. 4 in the form of a sub-block (a frame rate setting part 225) of the overall controller 220.

The frame rate setting part 225 determines the current readout mode of the CCD 303, the current display mode of the LCD driver 210 and a current recording mode in accordance with a predetermined rule, based on the current shooting scene mode set by means of the shooting scene selection button 21. The frame rate setting part 225 sets the current readout mode, the current display mode and the current recording mode to the respectively determined modes. Since the frame rate setting part 225 sets the current readout mode, the current display mode and the current recording mode in synchronism with each other, the image-capturing frame rate, the display frame rate, the recording frame rate, the image-capturing resolution, the display resolution and the recording resolution are changed in synchronism with each other. This enables the frame rate setting part 225 to perform a frame rate change process and a resolution change process for changing the image-capturing frame rate, the display frame rate, the recording frame rate, the image-capturing resolution, the display resolution and the recording resolution in synchronism with each other in response to a change of the current shooting scene mode.

<AF Control>

The digital camera 1A effects AF control for calculating the contrast of an in-focus condition evaluation region defined within a captured image to move the focusing lens element 301b to a lens position (referred to hereinafter as an “in-focus lens position”) which maximizes the contrast, thereby achieving an in-focus condition. In other words, the digital camera 1A effects contrast-based AF control.

For the AF control, the digital camera 1A is capable of performing two AF operations: (a) a one-shot AF operation in which the focusing lens element 301b is moved to and stopped at the in-focus lens position; and (b) a subject tracking AF operation in which the focusing lens element 301b is continuously maintained near the in-focus lens position while the in-focus condition evaluation region is caused to track the motion of the main subject included in the subject.

In the one-shot AF operation, the motion detector 230 outputs a control signal through the overall controller 220 to the AF motor M2 to cause the AF motor M2 to repeatedly drive the focusing lens element 301b a predetermined distance. Further, the motion detector 230 calculates the contrast of the in-focus condition evaluation region each time the focusing lens element 301b is driven, and causes the AF motor M2 to stop driving the focusing lens element 301b at the in-focus lens position. The in-focus condition evaluation region in the one-shot AF operation is fixed at a default position or at a manually user-specified position.

In the subject tracking AF operation, on the other hand, the motion detector 230 outputs a control signal through the overall controller 220 to the AF motor M2 to cause the AF motor M2 to repeatedly drive the focusing lens element 301b a predetermined distance near the most recently specified in-focus lens position. Further, the motion detector 230 calculates the contrast of the in-focus condition evaluation region to specify a new in-focus lens position each time the focusing lens element 301b is driven. By repeating such an operation, the motion detector 230 can specify a succession of new in-focus lens positions, and maintain the focusing lens element 301b near the in-focus lens position. In other words, the motion detector 230 measures a distance to the main subject in the direction of the optical axis OA substantially in real time. The in-focus condition evaluation region in the subject tracking AF operation moves while tracking the motion of the main subject in the direction perpendicular to the optical axis OA.

In the “still image capturing mode” of the digital camera 1A, the overall controller 220, upon detecting that the shutter release button 20 is placed in the half-pressed position (S1), provides a one-shot AF instruction signal to the motion detector 230 when the current shooting scene mode is set to a non-sport mode such as the “portrait mode,” “evening scene mode,” “night scene portrait and night scene mode,” “text mode” and “program mode.” The motion detector 230 performs the above-mentioned one-shot AF operation in response to the one-shot AF instruction signal.

In the “still image capturing mode” of the digital camera 1A, the overall controller 220, on the other hand, provides a full-time AF instruction signal to the motion detector 230 independently of the position of the shutter release button 20 when the current shooting scene mode is set to the “sport mode.” The motion detector 230 performs the above-mentioned subject tracking AF operation in response to the full-time AF instruction signal. Therefore, when the current shooting scene mode is set to the “sport mode,” the focusing lens element 301b is continuously driven to maintain the in-focus condition even during the live view display in the shooting standby state.

In the “moving image capturing mode” of the digital camera 1A, the overall controller 220 provides the fill-time AF instruction signal to the motion detector 230 independently of the position of the shutter release button 20, as in the case where the current shooting scene mode is set to the “sport mode” in the “still image capturing mode.” The motion detector 230 performs the above-mentioned subject tracking AF operation in response to the full-time AF instruction signal. Therefore, in the “moving image capturing mode,” the focusing lens element 301b is continuously driven to maintain the in-focus condition even during the live view display in the shooting standby state.

Next, a method of detecting the motion of the main subject in the direction perpendicular to the optical axis OA will be described.

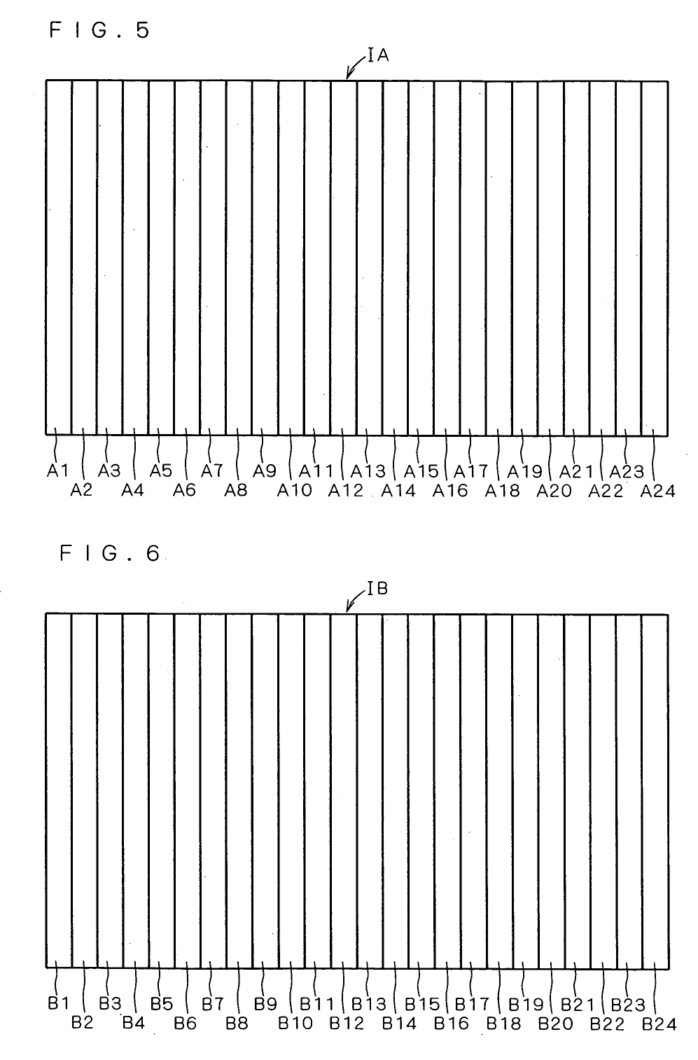

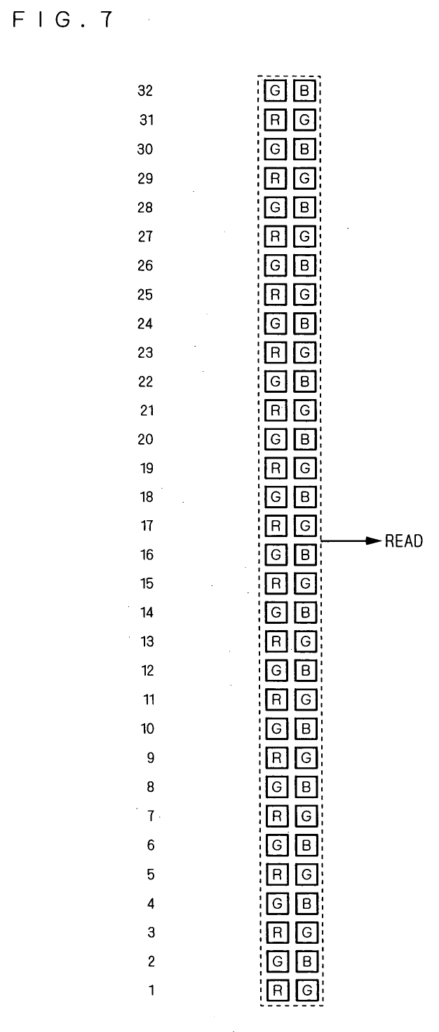

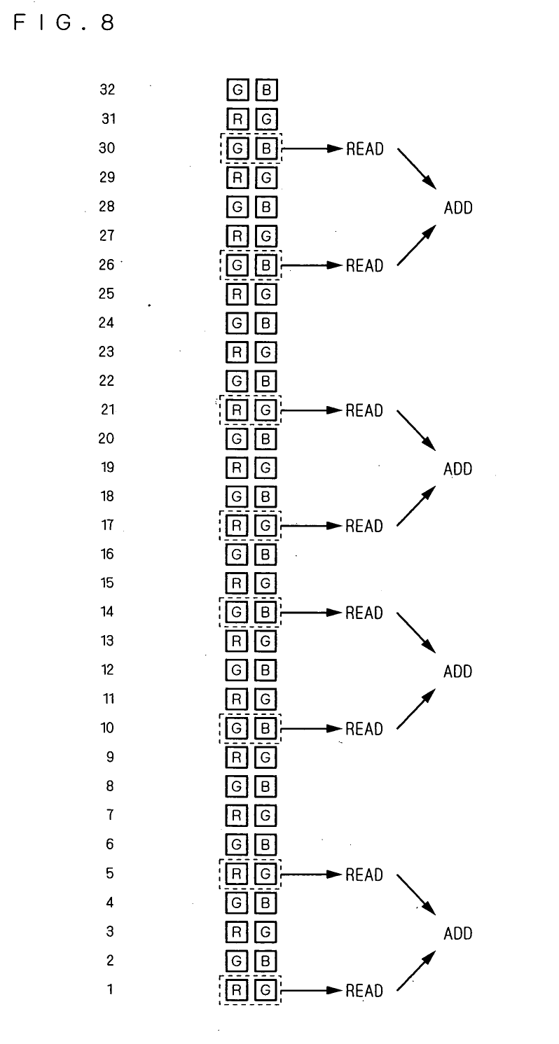

In the subject tracking AF operation, the motion of the main subject in the direction perpendicular to the optical axis OA is detected independently in two directions: the horizontal and the vertical. Since the methods of detecting the horizontal and vertical motions are substantially identical, only the method of detecting the horizontal motion will be described with reference to FIGS. 5 and 6, and description about the method of detecting the vertical motion will be omitted.

FIG. 5 shows that an image IA captured in a frame FA is divided into a plurality of equal areas A1 to A24. FIG. 6 shows that an image IB captured in a frame FB different from the frame FA is divided into a plurality of equal areas B1 to B24. The motion detector 230 detects the motion of the main subject by making a comparison between the images IA and IB.

More specifically, the motion detector 230 first calculates brightness values AY(1) to AY(24) and BY(1) to BY(24) in the areas A1 to A24 and B1 to B24, respectively. Each of the brightness values AY(1) to AY(24) and BY(1) to BY(24) is, for example, the sum of the brightness values of all pixels contained in a corresponding one of the areas A1 to A24 and B1 to B24.

Then, the motion detector 230 calculates brightness evaluation values PAT1 to PAT5 defined by Equations (1) to (5), respectively, from the brightness values AY(1) to AY(24) and BY(1) to BY(24).

$$\begin{matrix}PAT1 = {\sum }_{m = 2}^{23} \vert AY ( m ) - BY ( m ) \vert & ( 1 ) \\ PAT2 = {\sum }_{m = 2}^{23} \vert AY ( m ) - BY ( m - 1 ) \vert & ( 2 ) \\ PAT3 = {\sum }_{m = 2}^{23} \vert AY ( m ) - BY ( m + 1 ) \vert & ( 3 ) \\ PAT4 = {\sum }_{m = 2}^{23} \vert AY ( m + 1 ) - BY ( m - 1 ) \vert & ( 4 ) \\ PAT5 = {\sum }_{m = 2}^{23} \vert AY ( m - 1 ) - BY ( m + 1 ) \vert & ( 5 )\end{matrix}$$

The brightness evaluation value PAT1 is a parameter reflecting the degree of similarity between the areas A2 to A23 and the areas B2 to B23. The higher the degree of similarity between the areas A2 to A23 and the areas B2 to B23, the lower the brightness evaluation value PAT1.

Likewise, the brightness evaluation values PAT2, PAT3, PAT4 and PAT5 are parameters reflecting the degree of similarity between the areas A2 to A23 and the areas B1 to B22, the degree of similarity between the areas A2 to A23 and the areas B3 to B24, the degree of similarity between the areas A3 to A24 and the areas B1 to B22, and the degree of similarity between the areas A1 to A22 and the areas B3 to B24, respectively.

Subsequently, the motion detector 230 makes a comparison between the brightness evaluation values PAT1 to PAT5 to specify the lowest brightness evaluation value. The motion detector 230 judges that:
(1) the main subject has made no movement if the brightness evaluation value PAT1 is the lowest;
(2) the main subject has moved leftwardly the width of each of the areas if the brightness evaluation value PAT2 is the lowest;
(3) the main subject has moved rightwardly the width of each of the areas if the brightness evaluation value PAT3 is the lowest;
(4) the main subject has moved leftwardly twice the width of each of the areas if the brightness evaluation value PAT4 is the lowest; and
(5) the main subject has moved rightwardly twice the width of each of the areas if the brightness evaluation value PAT5 is the lowest.

Thus, the motion detector 230 compares the images captured in the different frames with each other while displacing the images with respect to each other, to judge that the main subject has moved a distance corresponding to the amount of displacement which maximizes the degree of similarity (or minimizes the brightness evaluation value). In the first preferred embodiment, the above-mentioned width of each of the areas corresponds to 80 (=1920÷24) pixels of the CCD 303.

The motion detector 230 performs the above-mentioned processing to detect the distance the main subject has moved. The motion detector 230 moves the position of the in-focus condition evaluation region through the detected distance to achieve the subject tracking AF operation.

<Readout Modes of CCD 303>

The “all-pixel readout mode,” “high-definition readout mode” and “high-speed readout mode” of the CCD 303 will be described with reference to FIGS. 7 to 9. FIGS. 7 to 9 illustrate readout methods in the “all-pixel readout mode,” “high-definition readout mode” and “high-speed readout mode,” respectively. FIGS. 7 to 9 schematically represent a pixel array with two columns and 32 rows extracted from the light-sensitive pixels of R, G and B color components arranged in the Bayer matrix. Squares with characters “R,” “G,” and “B” enclosed therein in FIGS. 7 to 9 correspond to light-sensitive pixels of the R, G and B color components, respectively. A dotted rectangle drawn to surround these light-sensitive pixels indicates the bounds of the light-sensitive pixels to be read. The numerals “1” to “32” to the left of the array of light-sensitive pixels are indices indicating the row positions reckoned from the bottom.

The CCD 303 changes the number of light-sensitive pixels to be read in accordance with the change of the current readout mode, which will be described below.

Referring to FIG. 7, all of the light-sensitive pixels of the CCD 303 are to be read in the “all-pixel readout mode.” The “all-pixel readout mode” is used when generating image data for actual shooting in the still image capturing mode.

Referring to FIG. 8, eight of the 32 rows of light-sensitive pixels of the CCD 303 are to be read in the “high-definition readout mode.” More specifically, the first, fifth, tenth, fourteenth, seventeenth, twenty-first, twenty-sixth and thirtieth rows shown in FIG. 8 are to be read. A vertical transfer part in the CCD 303 adds the pixel signals of the same color in the first and fourth rows together, adds the pixel signals of the same color in the tenth and fourteenth rows together, adds the pixel signals of the same color in the seventeenth and twenty-first rows together, and adds the pixel signals of the same color in the twenty-sixth and thirtieth rows together. As a result, an image signal in which the number of pixels arranged in the vertical direction is finally reduced to ⅛ by pixel skipping is outputted from the CCD 303. Thus, the CCD 303 outputs the image signal having an image-capturing resolution of 2560 pixels wide by 240 pixels high in the “high-definition readout mode.” In the “high-definition readout mode,” image signals are read at an image-capturing frame rate of 30 fps.

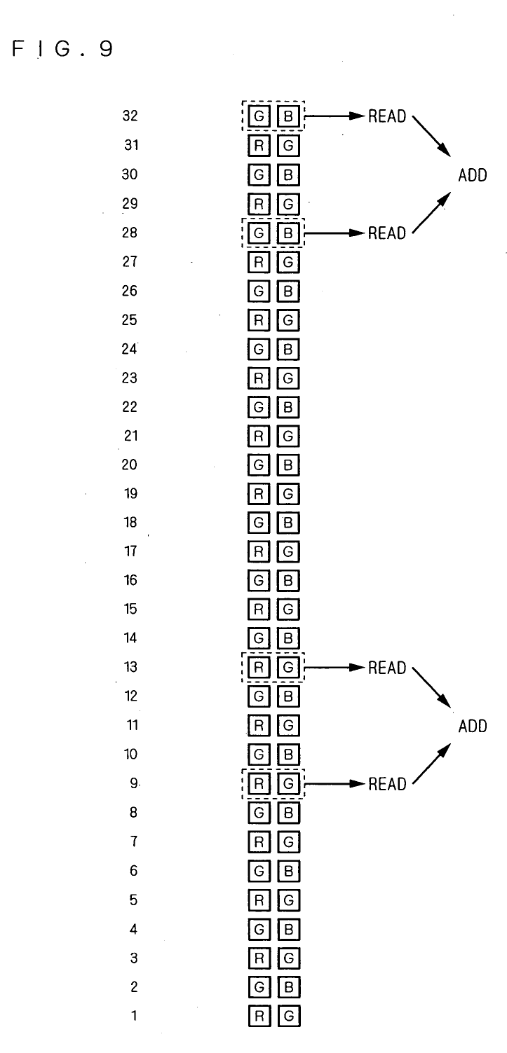

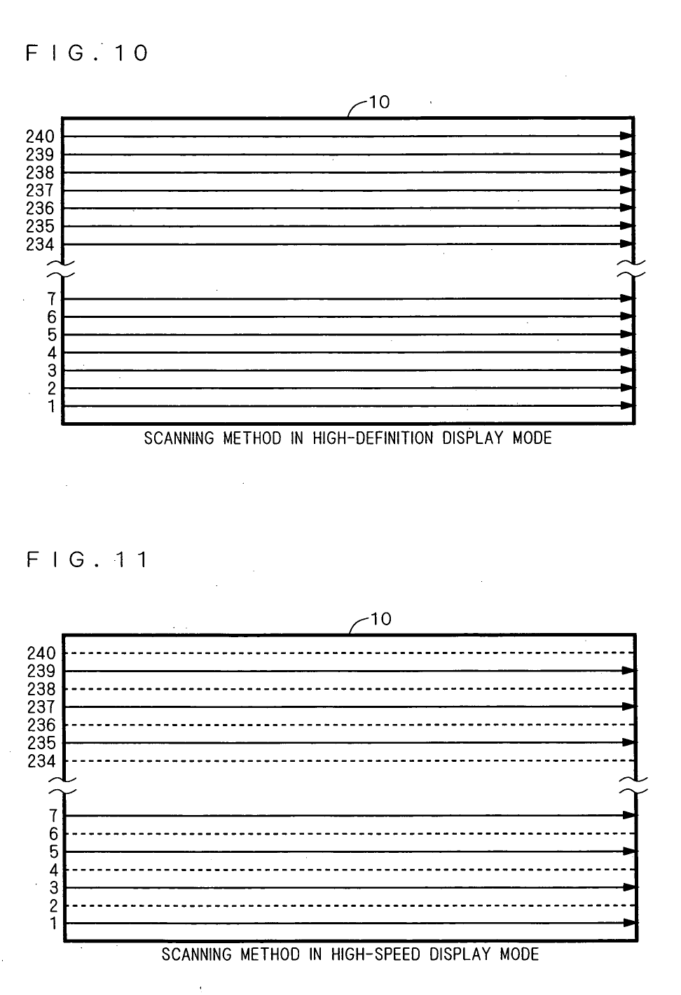

Referring to FIG. 9, four of the 32 rows of light-sensitive pixels of the CCD 303 are to be read in the “high-speed readout mode.” More specifically, the ninth, thirteenth, twenty-eighth and thirty-second rows shown in FIG. 9 are to be read. The vertical transfer part in the CCD 303 adds the pixel signals of the same color in the ninth and thirteenth rows together, and adds the pixel signals of the same color in the twenty-eighth and thirty-second rows together. As a result, an image signal in which the number of pixels arranged in the vertical direction is finally reduced to 1/16 by pixel skipping is outputted from the CCD 303. Thus, the CCD 303 outputs the image signal having an image-capturing resolution of 2560 pixels wide by 120 pixels high in the “high-speed readout mode,” which is lower in vertical resolution than that in the “high-definition readout mode.” In the “high-speed readout mode,” image signals are read at an image-capturing frame rate of 60 fps which is higher than in the “high-definition readout mode.”

The above-mentioned “high-definition readout mode” and “high-speed readout mode” are used when generating image data for live view display in the still image capturing mode and image data for live view display and for recording in the moving image capturing mode. The “high-definition readout mode” and the “high-speed readout mode” are equal in the product of the image-capturing frame rate and the image-capturing resolution, and are therefore substantially identical in required image processing resources. The image data outputted from the CCD 303 in the “high-definition readout mode” and “high-speed readout mode” are lower in vertical resolution than the image data outputted from the CCD 303 in the “all-pixel readout mode,” but are identical in image capturing range (or angle of view) with that in the “all-pixel readout mode.”

<Display Modes of LCD Driver 210>

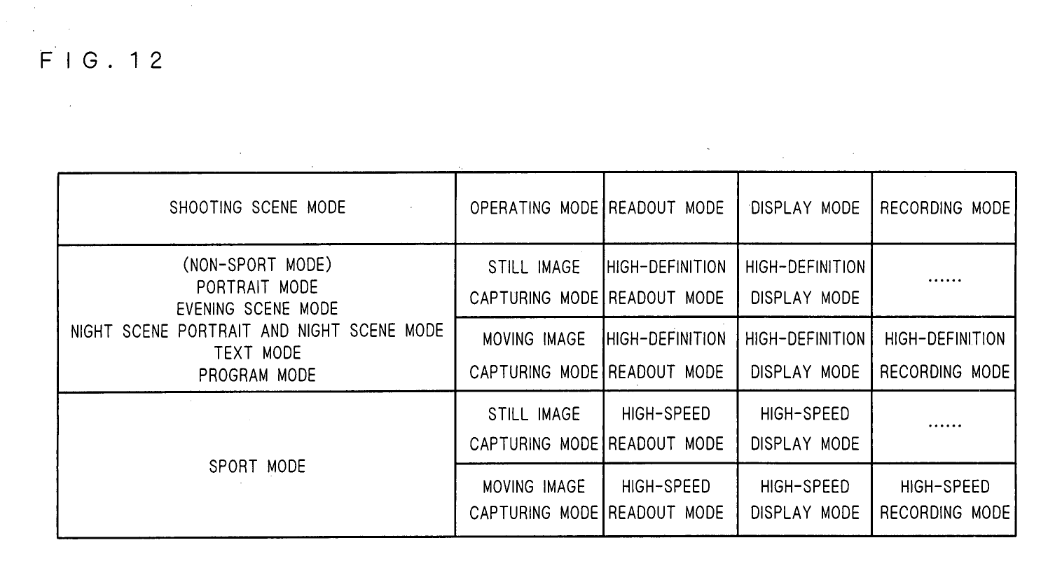

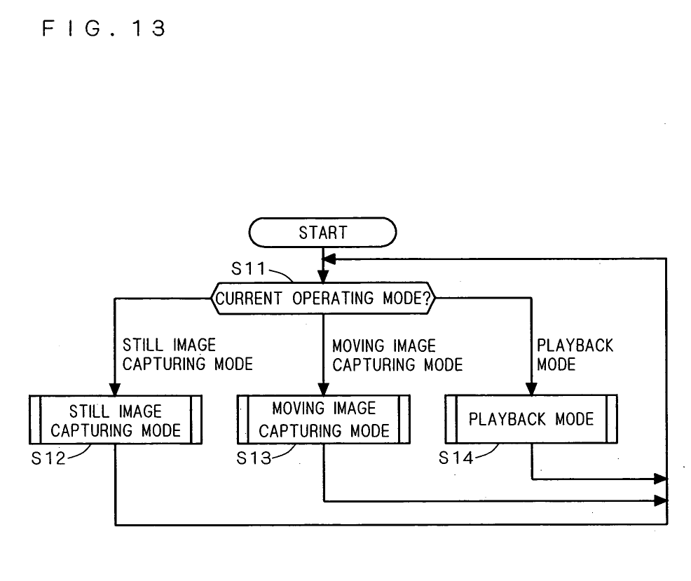

The “high-definition display mode” and “high-speed display mode” of the LCD driver 210 will be described with reference to FIGS. 10 and 11. FIGS. 10 and 11 illustrate scanning methods in the “high-definition display mode” and “high-speed display mode,” respectively. The numerals “1” to “240” to the left of the LCD 10 are indices indicating the row positions reckoned from the bottom. The LCD driver 210 changes the number of display pixels to be scanned in accordance with the change of the current display mode, which will be described below.

The direction of scanning of the display pixels of the LCD 10 is indicated by solid arrows in FIG. 10 which illustrates the “high-definition display mode.” In the “high-definition display mode,” the LCD driver 210 sequentially scans the first to 240th rows of the display pixels of the LCD 10 on a row-by-row basis. The LCD driver 210 scans each row from left to right. Thus, all of the display pixels, i.e. 360 pixels wide by 240 pixels high, are to be scanned in the “high-definition display mode.” The substantial display resolution in the “high-definition display mode” is 360 pixels wide by 240 pixels high corresponding to the number of pixels of the LCD 10. The scanning is carried out at a display frame rate of 30 fps in the “high-definition display mode.”

The direction of scanning of the display pixels of the LCD 10 is indicated by solid arrows in FIG. 11 which illustrates the “high-speed display mode.” In the “high-speed display mode,” the LCD driver 210 sequentially scans alternate ones of the first to 239th rows of the display pixels of the LCD 10. In other words, the LCD driver 210 sequentially scans odd-numbered rows, i.e. the first, third, fifth . . . and 239th rows, of the display pixels of the LCD 10. In still other words, the LCD driver 210 scans the display pixels of the LCD 10 the number of which in the vertical direction is reduced to ½ by pixel skipping. Thus, 360 display pixels wide by 120 display pixels high are to be scanned in the “high-speed display mode.”

Further, in the “high-speed display mode,” the LCD driver 210 causes the even-numbered rows (dotted rows in FIG. 11), i.e. the second, fourth, sixth, . . . and 240th rows, of the display pixels of the LCD 10 not to be scanned to produce the same displays as do the odd-numbered rows, i.e., the first, third, fifth, . . . and 239th rows, respectively. In other words, the LCD driver 210 interpolates the displays in the even-numbered rows not to be scanned by line doubling. This produces displays on all of the display pixels of the LCD 10. However, because the number of rows to be scanned in the “high-speed display mode” is one-half the number of rows to be scanned in the “high-definition display mode,” the substantial display resolution in the “high-speed display mode” is 360 pixels wide by 120 pixels high which is lower than that in the “high-definition display mode.” In the “high-speed display mode,” the scanning is carried out at a display frame rate of 60 fps which is higher than in the “high-definition display mode.”

The “high-definition display mode” and the “high-speed display mode” are equal in the product of the display frame rate and the display resolution, and are therefore substantially identical in required image processing resources. The images displayed on the LCD 10 in the “high-definition display mode” and in the “high-speed display mode” are different in vertical display resolution from each other, but have a constant image capturing range (or angle of view).

<Recording Modes>

Moving image data is recorded in the memory card 8 during actual shooting when the current operating mode is set to the “moving image recording mode.” The recording frame rate of the moving image data is variable between 30 fps and 60 fps. The recording operation of the moving image data has two recording modes: a “high-definition recording mode,” and a “high-speed recording mode.”

In the “high-definition recording mode,” image data having a recording resolution of 360 pixels wide by 240 pixels high is recorded at a recording frame rate of 30 fps.

In the “high-speed recording mode,” image data having a recording resolution of 360 pixels wide by 120 pixels high which is lower than that in the “high-definition recording mode” is recorded at a recording frame rate of 60 fps which is higher than that in the “high-definition recording mode.”

<Shooting Scene Modes>

Description will be given on the six shooting scene modes of the digital camera 1A, that is, the “portrait mode,” the “sport mode,” the “evening scene mode,” the “night scene portrait and night scene mode,” the “text mode” and the “program mode.”

The “portrait mode” is a shooting scene mode appropriate for photographing a person. A program line adopted in the “portrait mode” exhibits a wider aperture than in other shooting scene modes.

The “sport mode” is a shooting scene mode appropriate for photographing a fast moving object. A program line adopted in the “sport mode” gives a higher priority to a higher shutter speed than in other shooting scene modes to prevent camera shake.

The “evening scene mode,” the “night scene portrait and night scene mode,” and the “text mode” are shooting scene modes appropriate for photographing an evening scene, a night scene, and a character on a white background, respectively. A program line adopted in the “evening scene mode,” the “night scene portrait and night scene mode,” and the “text mode” has a characteristic intermediate between those in the “portrait mode” and the “sport mode.”

The “program mode” is a general-purpose shooting scene mode. In the “program mode,” the digital camera 1A is fully automatic.

<Exposure Modes>

Description will be given on the three exposure modes of the digital camera 1A, that is, the “program mode,” the “aperture priority mode” and the “shutter speed priority mode.”

In the “program mode,” the shutter speed and the aperture value are automatically determined by the digital camera 1A. When the current exposure mode is set to the “program mode,” the shooting scene mode is automatically set to the “program mode.”

In the “aperture priority mode,” the shutter speed is automatically determined by the digital camera 1A, based on the aperture value manually set by the user.

In the “shutter speed priority mode,” the aperture value is automatically determined by the digital camera 1A, based on the shutter speed manually set by the user.

<Relationship between Shooting Scene Modes, Operating Modes, Readout Modes, Display Modes and Recording Modes>

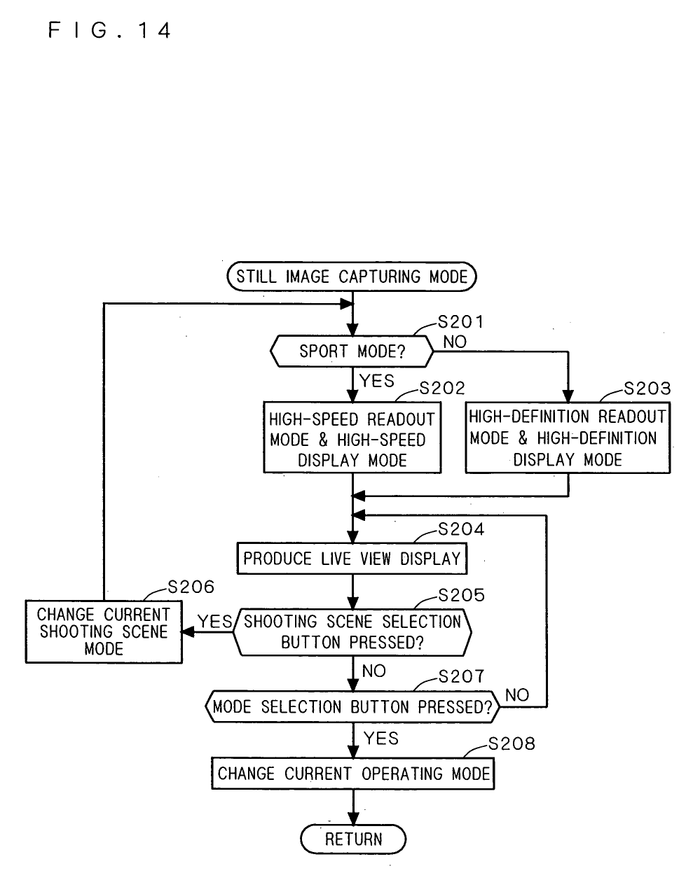

The digital camera 1A determines the current readout mode, the current display mode and the current recording mode, based on the set shooting scene mode. A relationship between the shooting scene modes, the operating modes, the readout modes, the display modes and the recording modes is shown in FIG. 12.

As shown in FIG. 12, when the current shooting scene mode is set to a non-sport mode such as the “portrait mode,” “evening scene mode,” “night scene portrait and night scene mode,” “text mode” and “program mode,” the current readout mode and the current display mode are set to the “high-definition readout mode” and the “high-definition display mode,” respectively, at the same time. Additionally, when the current operating mode is set to the “moving image capturing mode,” the current recording mode is also set to the “high-definition recording mode” at the same time.

On the other hand, when the current shooting scene mode is set to the “sport mode,” the current readout mode and the current display mode are set to the “high-speed readout mode” and the “high-speed display mode,” respectively, at the same time. Additionally, when the current operating mode is set to the “moving image capturing mode,” the current recording mode is set to the “high-speed recording mode” at the same time. In other words, the digital camera 1A increases the image-capturing frame rate, the display frame rate and the recording frame rate from 30 fps to 60 fps in synchronism with each other in response to the change of the current shooting scene mode from the non-sport mode to the “sport-mode.”

The above-mentioned current readout mode, current display mode and current recording mode are set at the same time by the frame rate setting part 225. Therefore, the image-capturing frame rate, the display frame rate, the recording frame rate, the image-capturing resolution, the display resolution and the recording resolution are changed in synchronism with each other in response to a change of the current shooting scene mode. In other words, the process of changing the frame rate and the process of changing the resolution are executed in synchronism with each other in the digital camera 1A.

The above-mentioned determination of the current readout mode, the current display mode and the current recording mode increases the frame rate in the sport mode in which it is desired to faithfully reproduce the fast motion of the subject in the form of a live view. The resolution, on the other hand, is increased in the non-sport mode in which it is desired to faithfully reproduce details. This allows the browsing of images at a frame rate and resolution appropriate for a shooting scene without increasing the image processing loads.

<Frame Rate Change Operation>

The frame rate change operation of the digital camera 1A will be described with reference to the flowchart of FIG. 13.

Step S11 to be executed first is the step of performing a branching process depending on the currently set operating mode. If the current operating mode is set to the “still image capturing mode” in Step S11, the operation flow proceeds to Step S12. If the current operating mode is set to the “moving image capturing mode,” the operation flow proceeds to Step S13. If the current operating mode is set to the “playback mode,” the operation flow proceeds to Step S14.

Steps S12, S13 and S14 are the steps of executing subroutines for the “still image capturing mode,” for the “moving image capturing mode” and for the “playback mode,” respectively. After the execution of the subroutines, the operation flow returns to Step S11.

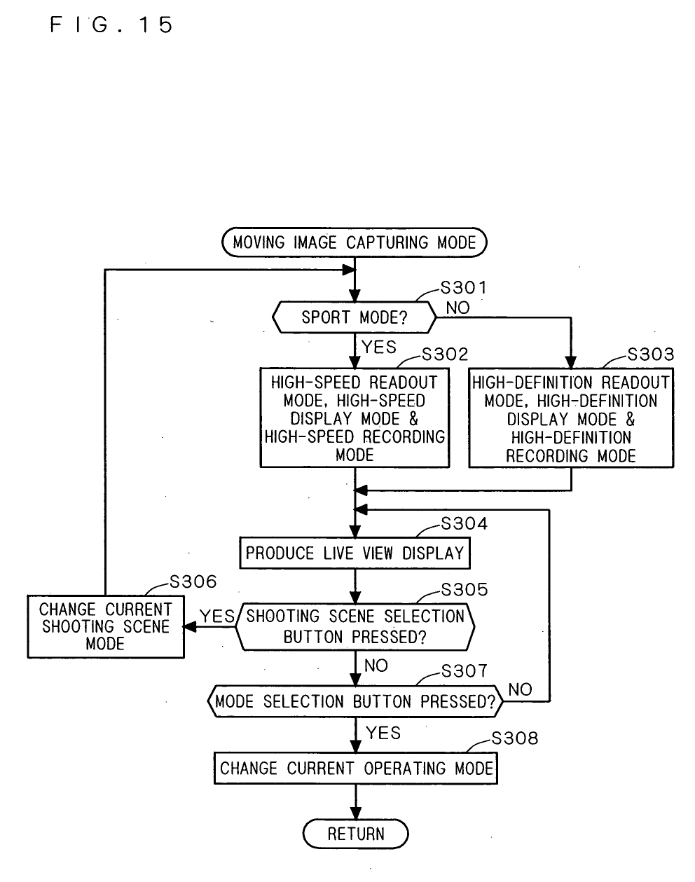

The subroutines for the “still image capturing mode,” for the “moving image capturing mode” and for the “playback mode” will be described with reference to FIGS. 14 to 16.

<Subroutine for Still Image Capturing Mode>

The first step S201 of the subroutine (in FIG. 14) for the “still image capturing mode” is the step of executing a branching process depending on the currently set shooting scene mode. If the current shooting scene mode is set to the “sport mode” in Step S201, the operation flow proceeds to Step S202. If the current shooting scene mode is set to a non-sport mode in Step S201, the operation flow proceeds to Step S203.

Steps S202 and S203 are steps in which the frame rate setting part 225 sets the current readout mode and the current display mode at the same time. In Step S202, the frame rate setting part 225 sets the current readout mode to the “high-speed readout mode,” and sets the current display mode to the “high-speed display mode.” In Step S203, on the other hand, the frame rate setting part 225 sets the current readout mode to the “high-definition readout mode,” and sets the current display mode to the “high-definition display mode.” Upon completion of Step S203 or S204, the operation flow proceeds to Step S204.

In Step S204, image data is read from the CCD 303 in the current readout mode set in Step S202 or S203, and a live view display of images is produced on the LCD 10 in the current display mode set in Step S202 or S203. Thus, the digital camera 1A allows the browsing of images at a frame rate and resolution appropriate for the current shooting scene mode.

Step S205 subsequent to Step S204 is the step of executing a branching process depending on the position of the shooting scene selection button 21. If a press of the shooting scene selection button 21 is detected in Step S205, the operation flow proceeds to Step S206. If a press of the shooting scene selection button 21 is not detected in Step S205, the operation flow proceeds to Step S207.

The process of changing the current shooting scene mode is performed in Step S206. Upon completion of the process in Step S206, the operation flow returns to Step S201.

Step S207 is the step of executing a branching process depending on the position of the mode selection button 16. If a press of the mode selection button 16 is detected in, Step S207, the operation flow proceeds to Step S208. If a press of the mode selection button 16 is not detected in Step S207, the operation flow returns to Step S204. Thus, the live view display is continued at the fixed frame rate unless the shooting scene selection button 21 and the mode selection button 16 are pressed. The current shooting scene mode is changed in response to a press of the shooting scene selection button 21, and the processes of changing the frame rate and the resolution are executed depending on the change of the current shooting scene mode.

The process of changing the current operating mode is performed in Step S208. Upon completion of the process in Step S208, the subroutine for the “still image capturing mode” is terminated.

<Subroutine for Moving Image Capturing Mode>

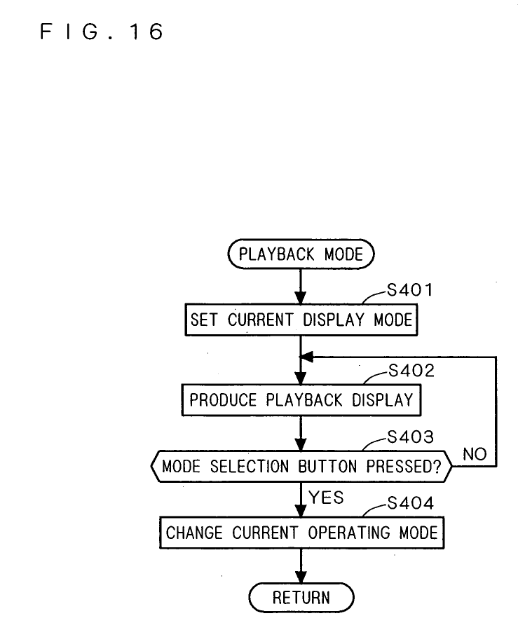

Steps S301 to S308 of the subroutine (in FIG. 15) for the “moving image capturing mode” correspond respectively to Steps S201 to S208 of the subroutine (in FIG. 14) for the “still image capturing mode.” In Steps S301 to S308, processes similar to those in Steps S201 to S208 are executed. A difference lies in that the current recording mode, in addition to the current readout mode and the current display mode in Steps S202 and S203, is also set in Steps S302 and S303. Specifically, the current recording mode is set to the “high-speed recording mode” in Step S302, and the current recording mode is set to the “high-definition recording mode” in Step S303.

This allows the recording of image data on the memory card 8 at a frame rate and resolution appropriate for the current shooting scene mode.

<Subroutine for Playback Mode>

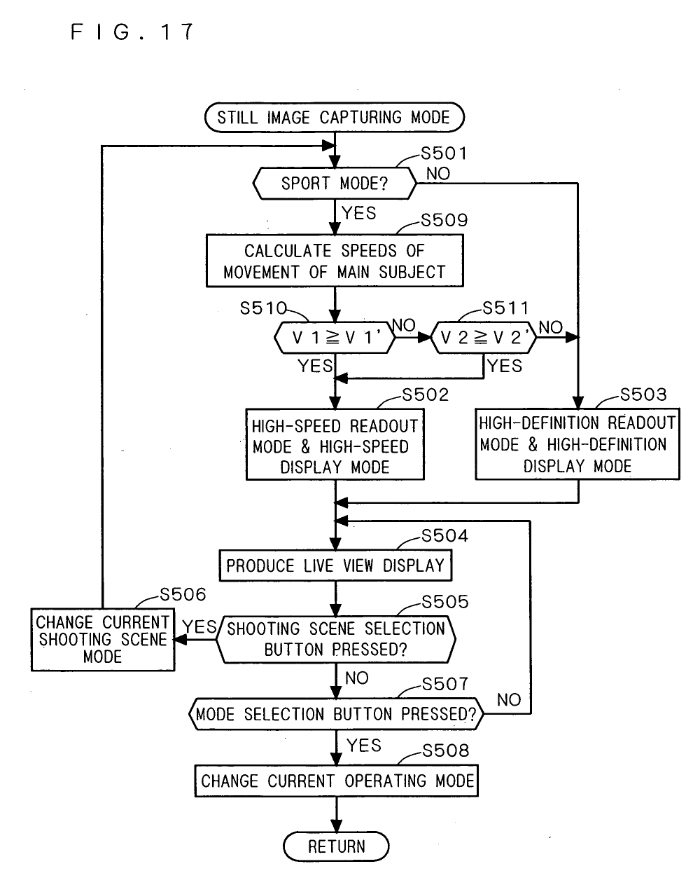

In the first step S401 of the subroutine (in FIG. 16) for the “playback mode,” the frame rate setting part 225 sets the current display mode to a predetermined mode. Thereafter, the operation flow proceeds to Step S402. The current display mode set in Step S401 is not particularly limited.

In Step S402, a playback of images is displayed on the LCD 10 in the current display mode set in Step S401.

Step S403 subsequent to Step S402 is the step of executing a branching process depending on the position of the mode selection button 16. If a press of the mode selection button 16 is detected in Step S403, the operation flow proceeds to Step S404. If a press of the mode selection button 16 is not detected in Step S403, the operation flow returns to Step S402. Thus, the playback display is continued unless the mode selection button 16 is pressed to change the current operating mode.

The process of changing the current operating mode is performed in Step S404. Upon completion of the process in Step S404, the subroutine for the “playback mode” is terminated.

<<Second Preferred Embodiment>>

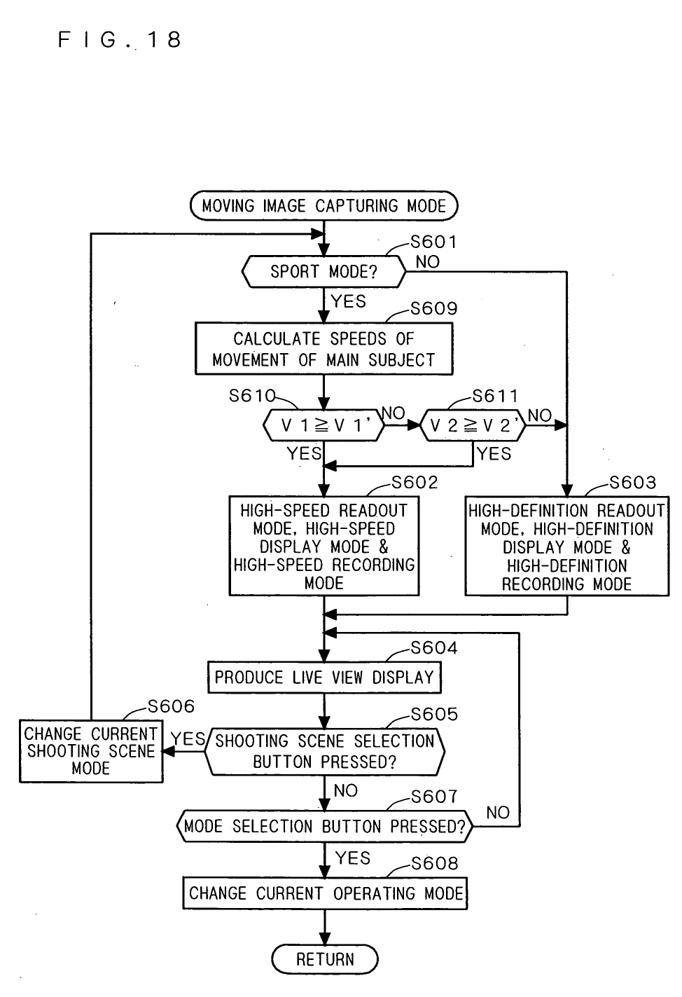

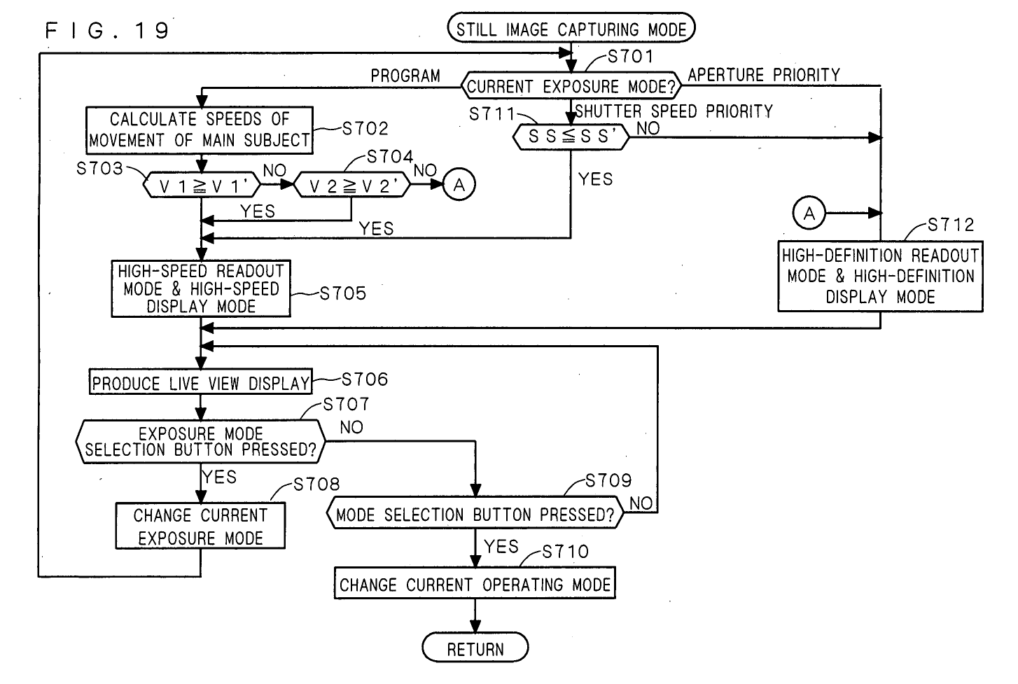

A digital camera 1B according to a second preferred embodiment of the present invention is similar in construction to the digital camera 1A according to the first preferred embodiment. The digital camera 1B, however, differs in operation from the digital camera 1A because a control program installed in the ROM 221 of the digital camera 1B differs from the control program in the digital camera 1A. More specifically, the digital camera 1B performs an automatic change process (autonomous change process) on the frame rate and the resolution, based on the result of detection of the motion detector 230 when the current shooting scene mode is set to the “sport mode.” This difference will be discussed with reference to the flowchart of FIG. 17 showing a subroutine for the “still image capturing mode” and the flow chart of FIG. 18 showing a subroutine for the “moving image capturing mode.” Commonalities with the digital camera 1A will be omitted in the following description.

<Subroutine for Still Image Capturing Mode>

FIG. 17 is a flowchart illustrating an operation flow in the “still image capturing mode” of the digital camera 1B.

The first step S501 of the subroutine for the “still image capturing mode” corresponds to Step S201 (in FIG. 14). If the current shooting scene mode is set to the “sport mode” in Step S501, the operation flow proceeds to Step S509. If the current shooting scene mode is set to a non-sport mode, the operation flow proceeds to Step S503.

Step S509 is the step of calculating the motion (or the speed of movement) of the main subject from information about AF (information about the in-focus lens position and the position of the in-focus condition evaluation region) specified by the motion detector 230. More specifically, the speed V1 of movement of the main subject in the direction of the optical axis OA is calculated from the frame rate and the amount of movement of the in-focus lens position, and the speed V2 of movement of the main subject in a direction perpendicular to the optical axis OA is calculated from the frame rate and the amount of movement of the in-focus condition evaluation region. Upon completion of these calculation processes, the operation flow proceeds to Step S510.

In Step S510, a branching process is performed depending on a result of comparison between the speed V1 of movement and a predetermined threshold value V1′. Specifically, if the speed V1 of movement is not less than the threshold value V1′, the operation flow proceeds to Step S502. If the speed V1 of movement is less than the threshold value V1′, the operation flow proceeds to Step S511.

In Step S511, a branching process is performed depending on a result of comparison between the speed V2 of movement and a predetermined threshold value V2′. Specifically, if the speed V2 of movement is not less than the threshold value V2′, the operation flow proceeds to Step S502. If the speed V2 of movement is less than the threshold value V2′, the operation flow proceeds to Step S503.

Steps S502 and S503 correspond respectively to Steps S202 and S203 (in FIG. 14). In Step S502, the frame rate setting part 225 sets the current readout mode to the “high-speed readout mode,” and sets the current display mode to the “high-speed display mode.” In Step S503, the frame rate setting part 225 sets the current readout mode to the “high-definition readout mode,” and sets the current display mode to the “high-definition display mode.” Upon completion of Step S502 or S503, the operation flow proceeds to Step S504.

Steps S501 to S503 and Steps S509 to S511 increase the frame rate automatically (or autonomously) if the current shooting scene mode is set to the “sport mode” and one of the speeds V1 and V2 of movement is not less than the predetermined threshold value. This allows the browsing of images at a frame rate appropriate for the speeds of movement of the subject in the direction of the optical axis OA and in the direction perpendicular to the optical axis OA.

Steps S504 to S508 correspond respectively to Steps S204 to S208 (in FIG. 14). Processes similar to those in Steps S204 to S208 are performed in Steps S504 to S508.

<Subroutine for Moving Image Capturing Mode>

FIG. 18 is a flowchart illustrating an operation flow in the “moving image capturing mode” of the digital camera 1B.

Steps S601 to S611 of the subroutine for the “moving image capturing mode” correspond respectively to Steps S501 to S511 (in FIG. 17) of the subroutine for the “still image capturing mode.” Processes similar to those in Steps S501 to S511 are performed in Steps S601 to S611. A difference lies in that the current recording mode, in addition to the current readout mode and the current display mode in Steps S502 and S503, is also set in Steps S602 and S603. Specifically, the current recording mode is set to the “high-speed recording mode” in Step S602, and the current recording mode is set to the “high-definition recording mode” in Step S603. This allows the browsing and recording of image data at a frame rate appropriate for the speeds of movement of the subject in the direction of the optical axis OA and in the direction perpendicular to the optical axis OA.

<<Third Preferred Embodiment>>

A digital camera 1C according to a third preferred embodiment of the present invention is similar in construction to the digital camera 1A according to the first preferred embodiment. The digital camera 1C, however, differs in operation from the digital camera 1A because a control program installed in the ROM 221 of the digital camera 1C differs from the control program in the digital camera 1A. More specifically, in the “still image capturing mode,” the digital camera 1C performs the processes of changing the frame rate and the resolution, depending on a change of the current exposure mode and based on the result of detection of the motion detector 230. This difference will be discussed with reference to the flowchart of FIG. 19 showing a subroutine for the “still image capturing mode.” Commonalities with the digital cameras 1A and 1B will be omitted in the following description.

<Subroutine for Still Image Capturing Mode>

The first step S701 of the subroutine for the “still image capturing mode” is the step of executing a branching process depending on the current exposure mode. If the current exposure mode is set to the “program mode” in Step S701, the operation flow proceeds to Step S702. If the current exposure mode is set to the “shutter speed priority mode” in Step S701, the operation flow proceeds to Step S711. If the current exposure mode is set to the “aperture priority mode” in Step S701, the operation flow proceeds to Step S712.

In Step S702, the speeds V1 and V2 of movement of the main subject are calculated by a method similar to that in Step S509 of FIG. 17. Upon completion of these calculation processes, the operation flow proceeds to Step S703.

In Step S703, a branching process is performed depending on a result of comparison between the speed V1 of movement and the predetermined threshold value V1′. Specifically, if the speed V1 of movement is not less than the threshold value V1′, the operation flow proceeds to Step S705. If the speed V1 of movement is less than the threshold value V1′, the operation flow proceeds to Step S704.

In Step S704, a branching process is performed depending on a result of comparison between the speed V2 of movement and the predetermined threshold value V2′. Specifically, if the speed V2 of movement is not less than the threshold value V2′, the operation flow proceeds to Step S705. If the speed V2 of movement is less than the threshold value V2′, the operation flow proceeds to Step S712.

In Step S711, a branching process is performed depending on a result of comparison between a shutter speed SS manually set by the user and a predetermined threshold value SS′. Specifically, if the shutter speed SS is not higher than the threshold value SS′, the operation flow proceeds to Step S705. If the shutter speed SS is higher than the threshold value SS′, the operation flow proceeds to Step S712.

Steps S705 and S712 are steps in which the frame rate setting part 225 sets the current readout mode and the current display mode at the same time.

In Step S705, the frame rate setting part 225 sets the current readout mode to the “high-speed readout mode,” and sets the current display mode to the “high-speed display mode.” After the setting, the operation flow proceeds to Step S706. In Step S712, on the other hand, the frame rate setting part 225 sets the current readout mode to the “high-definition readout mode,” and sets the current display mode to the “high-definition display mode.” After the setting, the operation flow proceeds to Step S706.

In Step S706, image data is read from the CCD 303 in the current readout mode set in Step S705 or S712, and a live view display of images is produced on the LCD 10 in the current display mode set in Step S705 or S712.

This allows the browsing of images at a frame rate appropriate for the speeds of movement of the subject when the current exposure mode is set to the “program mode.” The frame rate is increased if the current exposure mode is set to the “shutter speed priority mode” and the shutter speed is higher. This allows the browsing of images at a frame rate appropriate for the shutter speed. If the current exposure mode is set to the “aperture priority mode,” the frame rate is lowered but the resolution is increased. This allows the browsing of images at a frame rate appropriate for the “aperture priority mode.”

Step S707 subsequent to Step S706 is the step of executing a branching process depending on the position of the exposure mode selection button 22. If a press of the exposure mode selection button 22 is detected in Step S707, the operation flow proceeds to Step S708. If a press of the exposure mode selection button 22 is not detected in Step S707, the operation flow proceeds to Step S709.

The process of changing the current exposure mode is performed in Step S708. Upon completion of the process in Step S708, the operation flow returns to Step S701.

Step S709 is the step of executing a branching process depending on the position of the mode selection button 16. If a press of the mode selection button 16 is detected in Step S709, the operation flow proceeds to Step S710. If a press of the mode selection button 16 is not detected in Step S709, the operation flow returns to Step S706. Thus, the live view display is continued at the fixed frame rate unless the mode selection button 16 is pressed to change the current operating mode.

The process of changing the current operating mode is performed in Step S710. Upon completion of the process in Step S710, the subroutine for the “still image capturing mode” is terminated.

<<Modifications>>

(1) Although the processes of changing the frame rate and the resolution are performed in synchronism with the change of the current shooting scene mode in the first preferred embodiment, the frame rate and the resolution may be changed in synchronism with the change of the current exposure mode. For instance, the frame rate may be lowered in synchronism with the change of the current exposure mode from the “shutter speed priority mode” to the “aperture priority mode.”

(2) Although the frame rate is changed in two levels, i.e. 30 fps and 60 fps, in the first to third preferred embodiments, the frame rate may be changed in three or more levels. For example, the image-capturing, display and recording modes having a frame rate of 15 fps may be applied to the “aperture priority mode,” in which case the resolution is further improved.

While the invention has been described in detail, the foregoing description is in all aspects illustrative and not restrictive. It is understood that numerous other modifications and variations can be devised without departing from the scope of the invention.

1. An image capturing apparatus comprising:
an image capturing part for capturing an image of a subject at a variable image-capturing frame rate to generate image data;
a display part for displaying an image associated with said image data at a variable display frame rate; and
a controller for controlling said image capturing part and said display part,
said controller being capable of performing a frame rate change process,
wherein said controller changes said image-capturing frame rate and said display frame rate in synchronism with each other from a first frame rate to a second frame rate in said frame rate change process.

2. An image capturing apparatus capable of capturing a moving image, comprising:
an image capturing part for capturing an image of a subject at a variable image-capturing frame rate to generate image data;
a recording part for recording said image data at a variable recording frame rate; and
a controller for controlling said image capturing part and said recording part,
said controller being capable of performing a frame rate change process,
wherein said controller changes said image-capturing frame rate and said recording frame rate in synchronism with each other from a first frame rate to a second frame rate in said frame rate change process.

3. The image capturing apparatus according to claim 1,
said image capturing apparatus having a plurality of shooting scene modes,
wherein said controller performs said frame rate change process in response to a change of a current one of said plurality of shooting scene modes.

4. The image capturing apparatus according to claim 1, further comprising
a detector for detecting the motion of a main subject included in said subject,
wherein said controller is capable of autonomously performing said frame rate change process, based on a result of detection of said detector.

5. The image capturing apparatus according to claim 1, wherein
said controller is capable of performing a resolution change process in synchronism with said frame rate change process, and
said controller changes the resolution of said image data from a first resolution to a second resolution in said resolution change process.

6. The image capturing apparatus according to claim 3, wherein
said plurality of shooting scene modes include a sport mode for a fast moving subject, and a non-sport mode other than said sport mode, and
said second frame rate is higher than said first frame rate when said frame rate change process is performed in response to a change of said current shooting scene mode from said non-sport mode to said sport mode.

7. The image capturing apparatus according to claim 4,
said image capturing apparatus having a plurality of shooting scene modes,
said plurality of shooting scene modes including a specific shooting scene mode,
wherein said controller autonomously performs said frame rate change process, based on the result of detection of said detector when a current one of said plurality of shooting scene modes is set to said specific shooting scene mode.

8. An image capturing apparatus comprising:
an image capturing part for capturing an image of a subject at a variable image-capturing frame rate to generate image data;
a display part for displaying an image associated with said image data at a variable display frame rate; and
a controller for controlling said image capturing part and said display part,
wherein said controller sets said image-capturing frame rate and said display frame rate to the same control frame rate at the same time.

9. An image capturing apparatus comprising:
an image capturing part for capturing an image of a subject at a variable image-capturing frame rate to generate image data;
a recording part for recording said image data at a variable recording frame rate; and
a controller for controlling said image capturing part and said recording part,
wherein said controller sets said image-capturing frame rate and said recording frame rate to the same control frame rate at the same time.

10. The image capturing apparatus according to claim 8,
said image capturing apparatus having a plurality of shooting scene modes,
wherein said controller determines said control frame rate, based on a current one of said plurality of shooting scene modes.

11. The image capturing apparatus according to claim 5, wherein
said second frame rate is higher than said first frame rate, and
said second resolution is lower than said first resolution.

12. The image capturing apparatus according to claim 4, wherein
said detector comprises a distance measuring part for measuring a distance to said main subject in the direction of an optical axis of said image capturing apparatus.

13. The image capturing apparatus according to claim 4, wherein
said detector comprises a calculation part for calculating a distance said main subject has moved in a direction perpendicular to an optical axis of said image capturing apparatus.

14. The image capturing apparatus according to claim 1, wherein
said image capturing part comprises an image capturing device including a plurality of light-sensitive pixels,
said image capturing apparatus changing the number of light-sensitive pixels to be read among said plurality of light-sensitive pixels to thereby change said image-capturing frame rate.

15. The image capturing apparatus according to claim 1, wherein
said display part comprises a display device including a plurality of display pixels,
said image capturing apparatus changing the number of display pixels to be scanned among said plurality of display pixels to thereby change said display frame rate.

16. The image capturing apparatus according to claim 1,
said image capturing apparatus having a plurality of exposure modes,
wherein said controller performs said frame rate change process in response to a change of a current one of said plurality of exposure modes.

17. The image capturing apparatus according to claim 16, wherein
said plurality of exposure modes include an aperture priority mode, and a non-aperture priority mode other than said aperture priority mode,
said image capturing apparatus effecting automatic exposure control, based on an aperture value manually set by a user in said aperture priority mode; and
said second frame rate is lower than said first frame rate in said frame rate change process,
said frame rate change process being performed in response to a change of said current exposure mode from said non-aperture priority mode to said aperture priority mode.

18. The image capturing apparatus according to claim 1,
said image capturing apparatus having a plurality of exposure modes,
said plurality of exposure modes including a shutter speed priority mode,
said image capturing apparatus effecting automatic exposure control, based on a shutter speed manually set by a user in said shutter speed priority mode,
wherein said second frame rate is higher than said first frame rate in said frame rate change process,
said frame rate change process being performed in response to manual setting of a higher shutter speed than a predetermined threshold value when a current one of said plurality of exposure modes is set to said shutter speed priority mode.
